(19) United States
(12) Patent Application Publication
(10) Pub. No.: US 2013/0022199 A1
(43) Pub. Date: Jan. 24, 2013

(54) ENCRYPTION METHOD AND APPARATUS FOR DIRECT COMMUNICATION BETWEEN TERMINALS

(71) Applicants: Eunkyung KIM, Daejeon (KR); Sung Cheol CHANG, Daejeon (KR); Sung Kyung KIM, Daejeon (KR); Won-Ik KIM, Daejeon (KR); Mi Young YUN, Daejeon (KR); Hyun LEE, Daejeon (KR); Chul Sik YOON, Seoul (KR); Kwang Jae LIM, Daejeon (KR)

(72) Inventors: Eunkyung KIM, Daejeon (KR); Sung Cheol CHANG, Daejeon (KR); Sung Kyung KIM, Daejeon (KR); Won-Ik KIM, Daejeon (KR); Mi Young YUN, Daejeon (KR); Hyun LEE, Daejeon (KR); Chul Sik YOON, Seoul (KR); Kwang Jae LIM, Daejeon (KR)

(73) Assignee: ELECTRONICS AND TELECOMMUNICATIONS RESEARCH INSTITUTE, Daejeon (KR)

(21) Appl. No.: 13/552,613

(22) Filed: Jul. 18, 2012

(30) Foreign Application Priority Data
Jul. 18, 2011 (KR) 10-2011-0071014
Jul. 17, 2012 (KR) 10-2012-0077917

(51) Int. Cl. H04L 9/28

(52) U.S. Cl. 380/255

(57) ABSTRACT

A method for performing direct communication between terminals includes: a transmitting terminal's encrypting data using a direct communication transport encryption key (DTEK) for direct communication; and transmitting the encrypted data to a receiving terminal, wherein the DTEK is managed in an SA (security association) defined within the transmitting terminal or the receiving terminal.

### CROSS-REFERENCE TO RELATED APPLICATION

This application claims priority to and the benefit of Korean Patent Application Nos. 10-2011-0071014 and 10-2012-0077917 filed in the Korean Intellectual Property Office on Jul. 18, 2011 and Jul. 17, 2012, the entire contents of which are incorporated herein by reference.

### BACKGROUND OF THE INVENTION

(a) Field of the Invention

The present invention relates to a mobile communication system. Particularly, the present invention relates to an encryption method and apparatus for direct communication between terminals in a mobile communication system.

(b) Description of the Related Art

In the event of a disaster or calamity, important social infrastructure may be destroyed or damaged. Some of the important social infrastructure includes a variety of communication facilities such as wireless phones, wired phones, internet networks, etc. Destruction or damage of such communication facilities would increase social chaos following a disaster and reduce society's ability to recover from the disaster. Therefore, it is crucial to provide high-reliability support for means to quickly recover or replace the communication facilities. A mobile communication system with high reliability also referred to as an HR-Network. For example, one of the functions that IEEE 802.16n system has to be equipped with is the function of direct communication between terminals.

To this end, direct communication between terminals should be possible without the help of a base station or relay station. Moreover, encrypted data transmission is required to ensure reliability. This requires that mutual data transmission and related key management are to be encrypted without the help of an existing server in charge of security.

### SUMMARY OF THE INVENTION

The present invention has been made in an effort to provide an encryption method and apparatus for direct communication between terminals.

An exemplary embodiment of the present invention provides a method for performing direct communication between terminals, the method including: a transmitting terminal's encrypting data using a direct communication transport encryption key (DTEK) for direct communication; and transmitting the encrypted data to a receiving terminal, wherein the DTEK is managed in an SA (security association) defined within the transmitting terminal or the receiving terminal.

An exemplary embodiment of the present invention provides an encryption method for direct communication between terminals, the method including: deriving a direct communication transport encryption key (DTEK) for direct communication from a direct communication authentication key (DAK); and encrypting a direct communication packet using the DTEK.

An exemplary embodiment of the present invention provides an encryption apparatus including: an RF (radio frequency) unit; and a processor, the processor being configured to derive a direct communication transport encryption key (DTEK) for direct communication from a direct communication authentication key (DAK) and encrypt a direct communication packet using the DTEK.

### BRIEF DESCRIPTION OF THE DRAWINGS

FIG. 1 is a view of an environment supporting direct communication between terminals according to an exemplary embodiment of the present invention.

FIG. 2 is a view showing a security key system for data encryption for direct communication.

FIG. 3 is a flowchart showing a security key update method according to an exemplary embodiment of the present invention.

FIG. 4 is a flowchart showing a security key update method according to another exemplary embodiment of the present invention.

FIG. 5 is a flowchart showing a security key update method according to yet another exemplary embodiment of the present invention.

FIG. 6 illustrates a terminal applicable to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

In this specification, a mobile station (MS) may designate a terminal, a mobile terminal (MT), a mobile station (MS), an advanced mobile station (AMS), a high reliability mobile station (HR-MS), a subscriber station (SS), a portable subscriber station (PSS), an access terminal (AT), user equipment (UE), etc., and may include the entire or partial functions of the terminal, the MT, the MS, the AMS, the HR-MS, the SS, the PSS, the AT, the UE, etc.

In this specification, a base station (BS) may designate an advanced base station (ABS), a high reliability base station (HR-BS), a nodeB, an evolved nodeB (eNodeB), an access point (AP), a radio access station (RAS), a base transceiver station (BTS), a mobile multihop relay (MMR-BS), a relay station (RS) serving as a base station, a high reliability relay station (HR-RS) serving as a base station, etc., and may include the entire or partial functions of the ABS, the nodeB, the eNodeB, the AP, the RAS, the BTS, the MMR-BS, the RS, the HR-RS, etc.

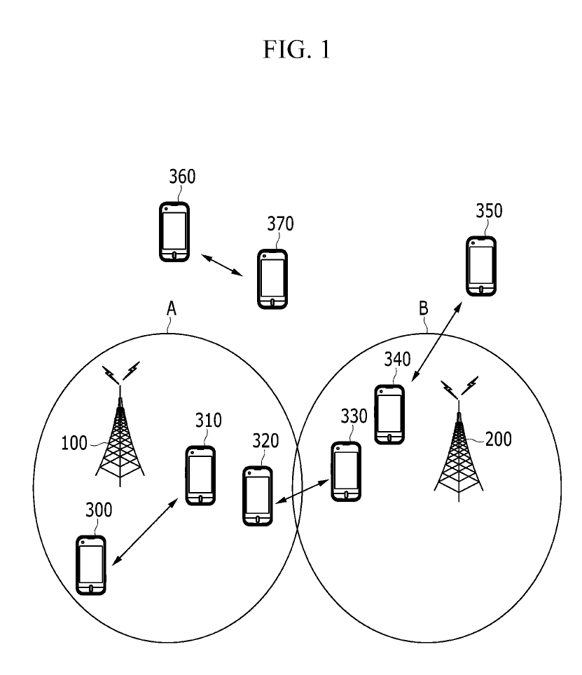

FIG. 1 is a view an environment supporting direct communication between terminals according to an exemplary embodiment of the present invention. Hereinafter, direct communication between terminals may simply be referred to as direct communication.

Referring to FIG. 1, at least one terminal 300, 310, 320, 330, 340, 350, 360, and 370 is located within or out of the cell coverage A and B of base stations 100 and 200. Possible scenarios of direct communication between terminals are that both of the two terminals 300 and 310 performing direct communication are within the cell coverage of the same base station, that the two terminals 320 and 330 performing direct communication are within the cell coverage of different base stations, that one of the two terminals 340 and 350 performing direct communication is within cell coverage and the other one is out of cell coverage, and that both of the two terminals 360 and 370 performing direction communication are out of cell coverage.

The terminals 300, 310, and 320 within the cell coverage A are capable of cellular communication with the base station 100, and the terminals 330 and 340 within the cell coverage B are capable of cellular communication with the base station 200.

To perform direct communication between terminals, there is a need for a method of mutual encryption of data without the help of a server, and a method of key management for encryption.

st, a security key for data encryption for direct communication will be explained.

A security key according to an exemplary embodiment of the present invention is DAK (direct communication authentication key). The DAK may be, for example, 160 bits long.

The DAK is a key shared among terminals participating in direct communication. If there are three or more terminals participating in direct communications, the terminals may form a group. Terminals in one group can share the same DAK. That is, the DAK is a unique key among terminals or groups participating in direct communication.

The DAK may be encrypted by a base station and transmitted in a unicast format to a terminal, or may be shared in advance by a terminal.

Meanwhile, a base station may receive a DMSK (direct communication master key) or a DPMK (direct communication pairwise master key) from a terminal and derive the DAK. The DPMK is a portion corresponding to the 160-bit LSB (least significant bit) of the DMSK.

Equation 1 shows an example of derivation of the DAK.

DAK=Dot16KDF (DPMK, MS1 Addressing|MS2 Addressing|“AK”, 160) (Equation 1)

where MS1 Addressing and MS2 Addressing are an MSID (mobile station ID) or MSID* of a terminal intending to perform direct communication. The MSID or MSID* may consist of 48 bits. Also, “AK” may be replaced with “DAK”. Dot16KDF (key, astring, keylength) is defined in 7.5.4.6 of IEEE 802.16-2009. Equation 2 is an example of derivation of MSID*.

MSID*=Dot16KDF(MSID|80 bit zero padding, NONCE_MS, 48) (Equation 2)

where NONCE_MS is a random 64-bit value derived by the terminal. MSID* may be used for connection settings such as ranging, synchronization, etc. for direct communication. Doti 6KDF (key, astring, keylength) is defined in 7.5.4.6 of IEEE 802.16-2009.

Equation 3 shows another example of derivation of the DAK.

DAK=Dot16KDF (DPMK, MS1 Addressing|DCGroupID|“AK”, 160) (Equation 3)

where MS1 Addressing is an MSID or MSID* of a terminal intending to perform direct communication. If there are two or more terminals participating in direct communication, the terminals may form a group. The ID assigned to the group is a DCGrouplD. Also, “AK” may be replaced with “DAK”. Dot16KDF (key, astring, keylength) is defined in 7.5.4.6 of IEEE 802.16-2009.

A security key according to another exemplary embodiment of the present invention is a DCMAC (direct communication cipher-based message authentication code)-DTEK (direct communication traffic encryption) prekey. The DCMAC-DTEK prekey is derived from DAK. The DCMAC-DTEK prekey is a key which is derived between terminals performing direct communication to derive a DCMAC key and DTEK.

Equation 4 shows an example of derivation of a DCMAC-DTEK prekey.

DCMAC-DTEK prekey=Dot16KDF (DAK, DAK_COUNT|“DCMAC-DTEK prekey”, 160) (Equation 4)

where DAK_COUNT is a counter which is required to generate and encrypt a DCMAC key and DTEK between terminals. When changing a target or group for direct communication, DAK_COUNT can be changed and updated. Dot16KDF (key, astring, keylength) is defined in 7.5.4.6 of IEEE

A security key according to another exemplar embodiment of the present invention is a DCMAC key. The DCMAC key is 128 bits long, and can be used for direct communication message authentication. A transmitting terminal and a receiving terminal participating in direct communication each may have a DCMAC key.

Equation 5 and Equation 6 are an example of derivation of a DCMAC key.

DCMAC_KEY_{—}S|DCMAC_KEY_{—}R=Dot16KDF(DCMAC-DTEK prekey, “DCMAC_KEYS”, 256) (Equation 5)

DCMAC_KEY_{—}R″DCMAC_KEY_{—}S=Dot16KDF(DCMAC-DTEK prekey, “DCMAC_KEYS”, 256) (Equation 6)

where DCMAC_KEY_S denotes the transmitting terminal, and DCMAC_KEY_R denotes the receiving terminal. Dot16KDF (key, astring, keylength) is defined in 7.5.4.6 of IEEE 802.16-2009.

A security key according to an exemplary embodiment of the present invention is DTEK (direct communication traffic encryption key). The DTEK is a transport encryption key to encrypt direct communication data. The DTEK is managed in an SA (security association) defined for direct communication. One SA manages two DTEKs, and each DTEK is derived as shown in Equation 7.

DTEKᵢ=Dot16KDF (DCMAC-DTEK prekey, DSAID|COUNTER_DTEK=i|“DTEK”, 128) (Equation 7)

where SA for direct communication manages DTEKs. COUNTER_DTEK is a counter used to derive different DTEKs in the same SA. To derive a new DTEK, the counter needs to be changed. Different DTEKs derived for the same SA can be derived through the same DAK/DAK_COUNT. Dot16KDF (key, astring, keylength) is defined in 7.5.4.6 of IEEE 802.16-2009.

If a DCMAC_DTEK prekey is derived, two DTEKs are derived. To derive a new DTEK, the counter can be reset to 0 or 1.

If DTEK PN (packet number) space is exhausted, or terminals participating in direct communication are re-authorized, a new DTEK is derived.

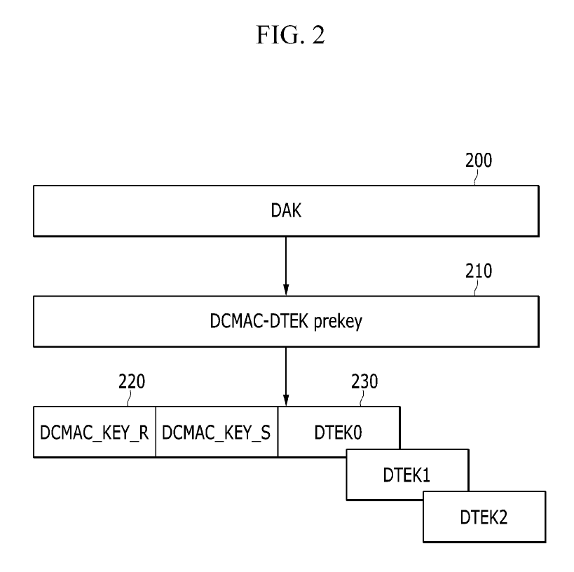

FIG. 2 is a view showing a security key system for data encryption for direct communication. A detailed description of the DAK, DCMAC_DTEK prekey, DCMAC key, and DTEK is similar to the foregoing description, so redundant description will be omitted.

Referring to FIG. 2, a DCMAC_DTEK prekey 210 is derived from a direct communication authentication key (DAK) 200 of 160 bits. The DCMAC_DTEK prekey 210 may be derived as shown in Equation 4.

Also, a DCMAC key 220 and DTEK 230 are derived from the DCMAC_DTEK prekey 210. The DCMAC key 220 may be derived as DCMAC_KEY_R and DCMAC_KEY_S for the transmitting terminal and the receiving terminal, respectively.

The DTEK 230 in the same SA can be counted.

DSA (direct communication security association) may be defined as information shared for encrypted data transmission during direct communication. DSA is identified by DSAID, and may exist independently from the existing SA.

Hereinafter, security context for direct communication will be described.

Table 1 is an example of DAK context.

TABLE 1

| | Size | |
|---|---|---|
| Parameter | (bits) | Usage |
| DAK | 160 | Shared by HR-MSs (between two or |
| | | among a group) |
| DAK_Lifetime | 32 | DAK Lifetime |
| DAKID | 64 | Identifies the authorization key |
| DAK_COUNT | 16 | A value used to derive the DCMAC key |
| | | and DTEK |
| DCMAC_KEY_S | 128 | The key which is used for signing MAC |
| | | control messages from sender (initiator) |
| | | to receiver (acceptor). |
| | | Here, the sender (initiator) denotes a |
| | | terminal that sends a direct |
| | | communication request and the receiver |
| | | (acceptor) denotes a terminal that |
| | | receives or accepts the direct |
| | | communication request. |
| DCMAC_PN_S | 24 | Used to avoid replay attack on the control |
| | | connection before this expires; |
| | | reauthorization is needed. The initial |
| | | value of DCMAC_PN_S is zero and the |
| | | value of DCMAC_PN_S is reset to zero |
| | | whenever DAK_COUNT is increased. |
| DCMAC_KEY_R | 128 | The key which is used for signing MAC |
| | | control messages to sender (initiator) |
| | | from receiver (acceptor). |
| | | Here, the sender (initiator) denotes a |
| | | terminal that sends a direct |
| | | communication request and the receiver |
| | | (acceptor) denotes a terminal that |
| | | receives or accepts the direct |
| | | communication request. |
| DCMAC_PN_R | 24 | Used to avoid replay attack on the control |
| | | connection before this expires; |
| | | reauthorization is needed. The initial |
| | | value of DCMAC_PN_R is zero and the |
| | | value of DCMAC_PN_R is reset to zero |
| | | whenever DAK_COUNT is increased. |
| Next available | 16 | The counter value to be used in the next |
| counter_DTEK | | DTEK derivation; after derivation this is |
| | | increased by 1. |

Referring to Table 1, the DAK context includes parameters such as DAK, DAK_Lifetime, DAKID, DAK_COUNT, DCMAC_KEY_S, DCMAC_PN_S, DCMAC_KEY_R, DCMAC_PN_RK, Next available counter_DTEK, etc.

Here, the DAK is an authentication key shared between terminals. The DAK_COUNT is a value used to drive a DCMAC key and DTEK. The DCMAC_KEY_S is a key for indicating a MAC control message from the transmitting terminal (sender) to the receiving terminal (receiver). The initial value of DCMAC_PN_S is set to zero, and the value of DCMAC_PN is reset to zero for each increment of DAK_COUNT. The DCMAC_KEY_R is a key for indicating a MAC control message from the receiving terminal to the transmitting terminal. The initial value of DCMAC_PN_R is set to zero, and the value of DCMAC_PN_R is reset to zero for each increment of DAK_COUNT. The Next available counter DTEK is a counter value used for next DTEK derivation, which shall be incremented by 1 after derivation.

Table 2 is an example of DSA context.

TABLE 2

| | Size | |
|---|---|---|
| Parameter | (bits) | Usage |
| DSAID | 8 | The identifier of this DSA, which describes |
| | | the applied encryption/decryption method |
| | | and DTEK contexts. |
| DTEK_{SRE} context | Size of | DTEK context used for encryption and |
| | (DTEK | decryption of link from initiator (sender) to |
| | context) | acceptor (receiver). |
| | | Here, the sender (initiator) denotes a |
| | | terminal that sends a direct communication |
| | | request and the receiver (acceptor) denotes |
| | | a terminal that receives or accepts the direct |
| | | communication request. |
| DTEK_{RSE} context | Size of | DTEK context used for encryption and |
| | (DTEK | decryption of link from acceptor (receiver) to |
| | context) | initiator (sender). |
| | | Here, the sender (initiator) denotes a |
| | | terminal that sends a direct communication |
| | | request and the receiver (acceptor) denotes |
| | | a terminal that receives or accepts the direct |
| | | communication request. |

Referring to Table 2, the DSA context includes DSAID, DTEK_{SRE}CONTEXT, and DTEK_{RSE}CONTEXT. The DSAID is an identifier of DSA, which describes the applied encryption/decryption method and DTEK context. The DTEK_{SRE}CONTEXT is DTEK context used for encryption and decryption of a link from the transmitting terminal to the receiving terminal, and the DTEK_{RSE}CONTEXT is DTEK context used for encryption and decryption of a link from the receiving terminal to the transmitting terminal. In this specification, the transmitting terminal may also be referred to as a speaker or initiator. The receiving terminal may also be referred to as a listener or acceptor.

Table 3 is an example of DTEK context.

TABLE 3

| | Size | |
|---|---|---|
| Parameter | (bits) | Usage |
| DTEK | 128 | Key used for encryption or decryption of |
| | | MAC PDUs from FIDs associated with the |
| | | corresponding DSA |
| DEKS | 2 | Encryption key sequence number |
| COUNTER | 16 | The counter value used to derive this DTEK |
| DTEK | | |
| DTEK lifetime | 32 | DTEK lifetime |
| DTEK PN S | 22 | The PN used for encrypting packets from |
| | | initiator to acceptor. After each MAC PDU |
| | | transmission, the value shall be increased by |
| | | 1. (0x000000-0x1FFFFF). |
| | | Here, the sender (initiator) denotes a |
| | | terminal that sends a direct communication |
| | | request and the receiver (acceptor) denotes |
| | | a terminal that receives or accepts the direct |
| | | communication request. |
| DTEK PN R | 22 | The PN used for encrypting packets from |
| | | acceptor to initiator. After each MAC PDU |
| | | transmission, the value shall be increased by |
| | | 1. (0x000000-0x1FFFFF). |
| | | Here, the sender (initiator) denotes a |
| | | terminal that sends a direct communication |
| | | request and the receiver (acceptor) denotes |
| | | a terminal that receives or accepts the direct |
| | | communication request. |
| PN Window | As | The receiver shall track the PNs received |
| Size | negotiated | inside PN window |
| | in key | |
| | agreement | |

Referring to Table 3, the DTEK context includes DTEK, DEKS, COUNTER_DTEK, DTEK lifetime, DTEK_PN_S, DTEK_PN_R, and PN Window Size. The DTEK is a key used for encryption or decryption of MAC PDUs from FIDs associated with the corresponding DSA. The DEKS is an encryption key sequence number. The COUNTER_DTEK is a counter value used to derive DTEK. The DTEK_PN_S is a PN (packet number) used for encrypting packets from the transmitting terminal to the receiving terminal. After each MAC PDU transmission, the value shall be incremented by 1. The DTEK_PN_R is a PN used for encrypting packets from the receiving terminal to the transmitting terminal.

Hereinafter, a method for updating a security key for data encryption for direct communication will be described.

Any terminal participating in direct communication can update the security key for data encryption for direct communication. For example, when the lifetime of the security key expires, the terminal (initiator) that has initiated direct communication may update the security key, or the terminal that has accepted direct communication may update the security key.

Update of the security key may be performed for each of traffic transmitted via direct communication, or performed upon expiration of a predetermined period of time.

When updating the security key, a terminal that sends an update request may transmit DEKS as well. Also, update can be performed only when a new DEKS is received.

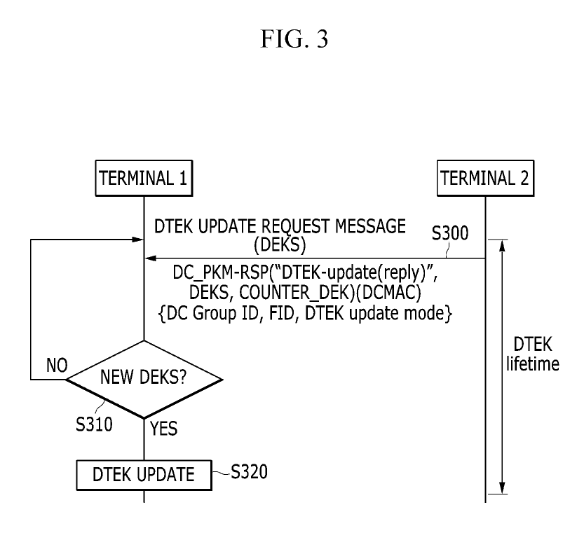

FIG. 3 is a flowchart showing a security key update method according to an exemplary embodiment of the present invention.

Referring to FIG. 3, one (terminal 2) of the terminals performing direct communication transmits a DTEK update request message to another terminal (terminal 1) (S300). The DTEK update request message may include DEKS.

Terminal 1 checks the DEKS included in the DTEK update request message (S310). If the DEKS is identical to the preceding DEKS, terminal 1 resets DTEK lifetime. If the DEKS is not identical to the preceding DEKS, terminal 1 updates the DTEK (S320). Afterwards, terminal 1 or terminal 2 may reset DTEK lifetime.

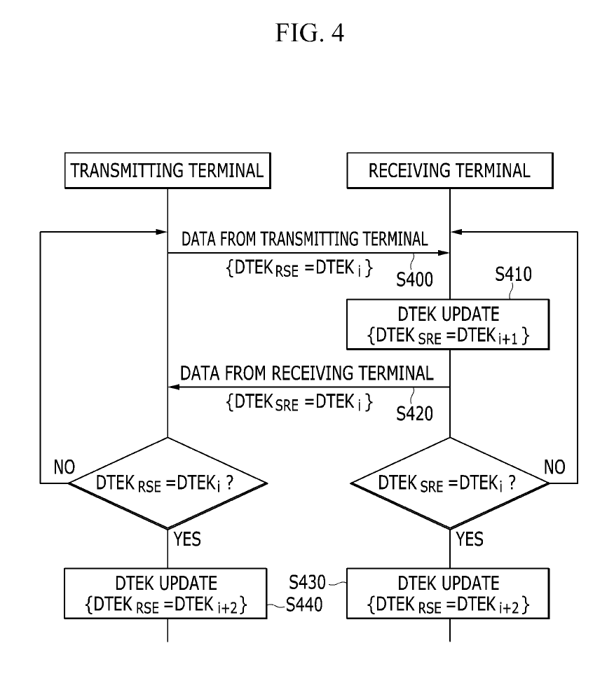

FIG. 4 is a flowchart showing a security key update method according to another exemplary embodiment of the present invention.

Referring to FIG. 4, during data transmission and reception between the transmitting terminal and the receiving terminal, when the transmitting terminal transmits data to the receiving terminal by DTEK_{RSE}=DTEKᵢ (S400), the receiving terminal updates DTEK_{RSE} to DTEKᵢ₊₁ (S410). Then, the receiving terminal transmits data to the transmitting terminal by DTEK_{RSE}=DTEKᵢ (S420). If DTEK_{RSE} equals DTEKᵢ, the receiving terminal updates DTEK_{RSE} to DTEKᵢ₊₂ (S430).

Having received data by DTEK_{RSE}=DTEKᵢ, the transmitting terminal updates DTEK_{RSE} to DTEKᵢ₊₂ if DTEK_{RSE} equals DTEK, (S440).

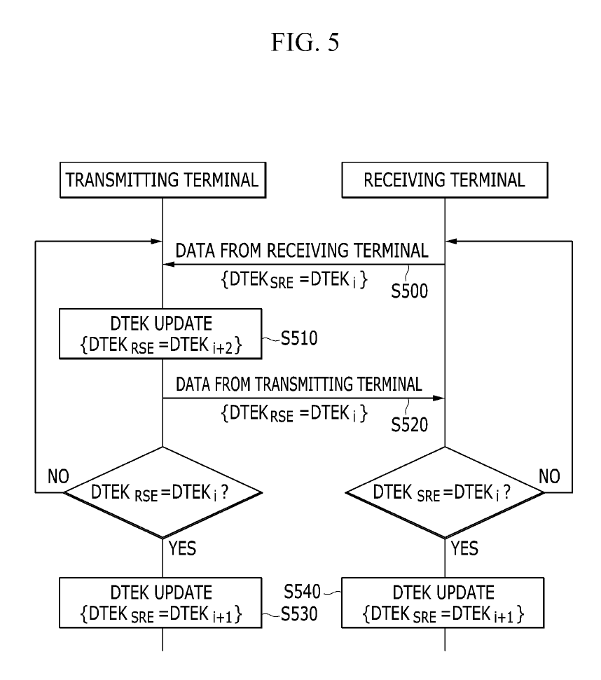

FIG. 5 is a flowchart showing a security key update method according to yet another exemplary embodiment of the present invention.

Referring to FIG. 5, during data transmission and reception between the transmitting terminal and the receiving terminal, when the transmitting terminal transmits data to the receiving terminal by DTEK_{RSE}=DTEKᵢ (S500), the receiving terminal updates DTEK_{RSE} to DTEKᵢ₊₂ (S510). Then, the receiving terminal transmits data to the transmitting terminal by DTEK_{RSE}=DTEKᵢ (S520). If DTE_{KRSE} equals DTEKᵢ, the receiving terminal updates DTEK_{RSE} to DTEKᵢ₊₁ (S530).

Having received data by DTEK_{RSE}=DTEKᵢ, the transmitting terminal updates DTEK_{RSE} to DTEKᵢ₊₁ if DTEK_{SRE} equals DTEKᵢ (S540).

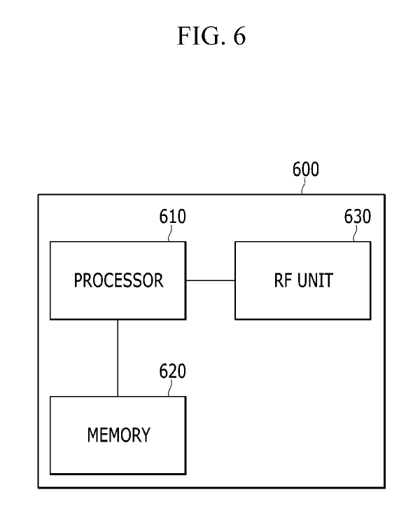

FIG. 6 illustrates a terminal applicable to an exemplary embodiment of the present invention.

Referring to FIG. 6, a terminal 600 includes a processor 610, a memory 620, and a radio frequency (RF) unit 630. The processor 610 may be configured to implement the procedures and/or methods proposed in the present invention. The memory 620 is connected to the processor 610, and stores various information related to the operation of the processor 610. The RF unit 630 is connected to the processor 610, and transmits and/or receives a radio signal. The terminal 600 may have a single antenna or multiple antennas.

According to an exemplary embodiment of the present invention, a security key applicable to direct communication between terminals can be derived. Moreover, data can be encrypted to be suited for direct communication between terminals, and security key update can be done.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for performing direct communication between terminals, the method comprising:
a transmitting terminal's encrypting data using a direct communication transport encryption key (DTEK) for direct communication; and
transmitting the encrypted data to a receiving terminal,
wherein the DTEK is managed in an SA (security association) defined within the transmitting terminal or the receiving terminal.

2. The method of claim 1, wherein
the SA further manages parameters related to the DTEK, and
the parameters related to the DTEK comprise at least one of a key-related sequence number, a counter value (COUNTER_DTEK) used to derive different DTEKs in the same SA, and a PN (packet number) used to encrypt DTEK lifetime and packets.

3. The method of claim 1, wherein the SA is identified by an identifier, and the identifier describes the applied encryption or decryption method and the managed parameters related to the DTEK.

4. An encryption method for direct communication between terminals, the method comprising:
deriving a direct communication transport encryption key (DTEK) for direct communication from a direct communication authentication key (DAK); and
encrypting a direct communication packet using the DTEK.

5. The method of claim 4, wherein the DAK is shared between two or more terminals participating in direct communication.

6. The method of claim 4, wherein parameters related to the DAK comprise at least one of DAK lifetime, an identifier (DAKID) of the DAK, a key (DCMAC_KEY) used for a direct communication MAC (medium access control) message, a PN (DCMAC_KEY) used to avoid attack on the direct communication MAC control message, and a value (DAK_COUNT) used to derive the DCMAC_KEY and the DTEK.

7. The method of claim 4, wherein the parameters related to the DTEK comprises at least one of a key-related sequence number, a counter value (COUNTER_DTEK) used to derive different DTEKs in the same SA, and a PN (packet number) used to encrypt DTEK lifetime and packets.

8. The method of claim 4, wherein the DAK is derived from a direct communication master key (DMK).

9. The method of claim 4, wherein the DAK is derived from identifiers of terminals participating in direct communication.

10. The method of claim 4, wherein
the deriving comprises:
deriving a DCMAC (direct communication cipher-based message authentication code)-DTEK (direct communication traffic encryption) prekey; and
deriving the DTEK from the DCMAC-DTEK prekey.

11. The method of claim 10, wherein the deriving further comprises deriving a DCMAC key used for message authentication from the DCMAC-DTEK prekey.

12. An encryption apparatus comprising:
an RF (radio frequency) unit; and
a processor,
the processor being configured to derive a direct communication transport encryption key (DTEK) for direct communication from a direct communication authentication key (DAK) and encrypt a direct communication packet using the DTEK.

13. The apparatus of claim 12, wherein the DTEK is managed in an SA (security association) for direct communication defined within a terminal.
